(19) United States
(12) Patent Application Publication
(10) Pub. No.: US 2016/0061291 A1
(43) Pub. Date: Mar. 3, 2016

(54) ECCENTRIC OSCILLATION GEAR DEVICE AND TORQUE ADJUSTING METHOD THEREFOR

(71) Applicant: NABTESCO CORPORATION, Tokyo (JP)

(72) Inventor: Hiroki MIZUHASHI, Mie (JP)

(21) Appl. No.: 14/833,678

(22) Filed: Aug. 24, 2015

(30) Foreign Application Priority Data
Aug. 28, 2014 (JP) 2014-173759

(51) Int. Cl. F16H 1/32

(52) U.S. Cl. CPC F16H 1/32; F16H 2001/323

(57) ABSTRACT

Disclosed is an eccentric oscillation gear device which comprises: an outer cylinder; a carrier provided with a motor installation section having an inside space; a main bearing configured to permit relative rotation between the outer cylinder and the carrier; a motor at least partly inserted into the inside space of the motor installation section; a spacer filling a gap between the motor installation section and the motor; and a crankshaft configured to be rotated in response to receiving a driving force from the motor, in such a manner as to cause relative rotation between the outer cylinder and the carrier.

### TECHNICAL FIELD

The present invention relates to an eccentric oscillation gear device and a method of adjusting torque of the eccentric oscillation gear device.

### BACKGROUND ART

Heretofore, there has been known an eccentric oscillation gear device comprising an outer cylinder, a carrier, a crankshaft, and a motor configured to driven the crankshaft to thereby cause relative rotation between the carrier and the outer cylinder, as disclosed in JP 2011-147223A and JP H02-041748U. For example, an eccentric oscillation gear device disclosed in JP 2011-147223A is configured such that an outer cylinder 91 and a carrier 92 are relatively rotatable with respect to each other via a bearing 93, as illustrated in FIG. 7. Additionally, a plurality of crankshafts 94 are rotatably supported by the carrier 92, and a plurality of motors 95 are attached to the crankshafts 94, respectively. When the crankshafts 94 are rotated by the respective motors 95, an oscillation gear 96 fitted on the crankshafts 94 is oscillatingly rotated. Thus, the carrier 92 is relatively rotated with respect to the outer cylinder 91.

In an eccentric oscillation gear device, a motor specification is determined according to a required torque. Thus, in a design and production process of the gear device, a motor appropriate to the required torque is selected, and then a carrier and others are selected in accordance with the motor. In the design and production process, if a motor and others are selected after finalization of the required torque, it becomes difficult to meet a delivery deadline for the gear device, in some cases. Thus, it is necessary to preliminarily ensure a certain level of stocks so as to achieve quick delivery of the gear device. In reality, however, the required torque can be changed from an initial specification. For making it possible to cope with such a situation, it is necessary to ensure stocks for a plurality of types of gear devices equipped with different motors according to various specifications. This causes storage space problems and production control problems.

### SUMMARY OF INVENTION

It is therefore an object of the present invention to provide an eccentric oscillation gear device capable of readily coping with a change of a required torque and contributing to a reduction in burden of stocks.

According one aspect of the present invention, there is provided an eccentric oscillation gear device which comprises: an outer cylinder; a carrier provided with a motor installation section having an inside space; a main bearing configured to permit relative rotation between the outer cylinder and the carrier; a motor at least partly inserted into the inside space of the motor installation section; a spacer filling a gap between the motor installation section and the motor; and a crankshaft configured to be rotated in response to receiving a driving force from the motor, in such a manner as to cause relative rotation between the outer cylinder and the carrier.

According one aspect of the present invention, there is provided a method of adjusting torque of an eccentric oscillation gear device, wherein the eccentric oscillation gear device comprises: an outer cylinder a carrier provided with a motor installation section having an inside space; a main bearing configured to permit relative rotation between the outer cylinder and the carrier; a motor installed in the motor installation section; and a crankshaft configured to be rotated in response to receiving a driving force from the motor, in such a manner as to cause relative rotation between the outer cylinder and the carrier. The method comprises; selectively determining a motor having a size appropriate to a required torque, within a size of the inside space of the motor installation section; inserting at least a portion of the determined motor into the inside space to install the motor in the motor installation section, while filling a gap between the motor installation section and the motor by using a spacer, thereby adjusting a relative rotation torque to be generated between the outer cylinder and the carrier.

### BRIEF DESCRIPTION OF DRAWINGS

FIG. 1 is a sectional view of an eccentric oscillation gear device according to one embodiment of the present invention, taken along the line I-I in FIG. 2.

FIG. 2 is a sectional view taken along the line II-II in FIG. 1.

FIG. 3 is a side view of the eccentric oscillation gear device, when viewed rightwardly from the left side in FIG. 1, wherein plugging members are removed therefrom.

FIG. 4 is a sectional view taken along the line IV-IV in FIG. 2.

FIG. 5 is a diagram illustrating another structure of a motor installation section.

FIG. 6 is a diagram illustrating another structure of a spacer.

FIG. 7 is an explanatory diagram of a conventional eccentric oscillation gear device.

### DESCRIPTION OF EMBODIMENTS

With reference to the drawings, one embodiment of the present invention will now be described in detail.

A gear device 1 according to this embodiment is designed to be applicable as a speed reducer, for example, to turning sections in a turning body, an arm joint and the like of a robot, and turning sections of various machine tools. For example, the gear device 1 is a gear transmission device provided between a base and a turning body relatively turnable with respect to the base and configured to output a driving force having a rotational speed reduced at a given ratio with respect to a rotational speed input thereto.

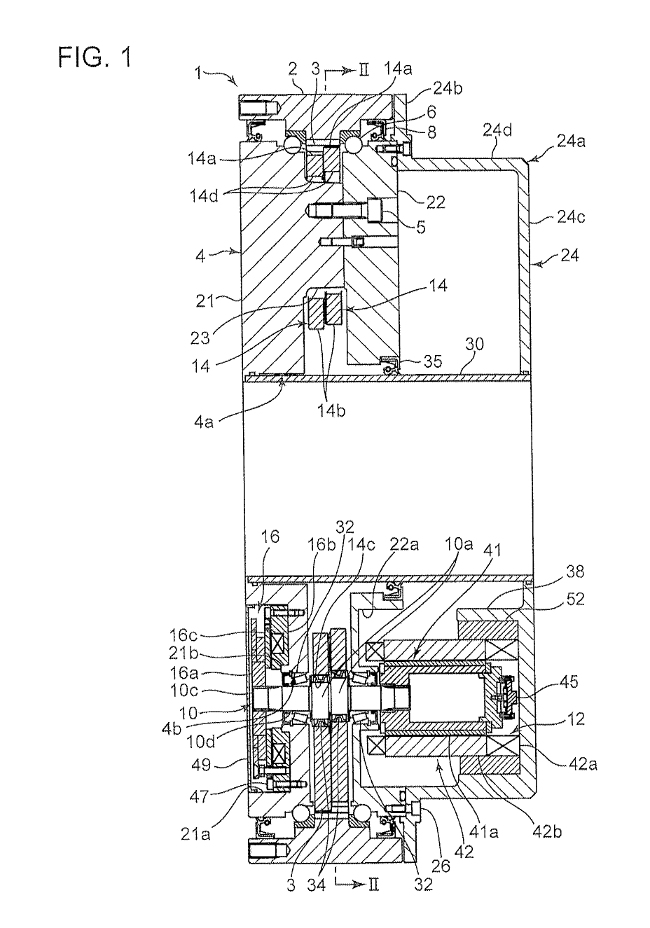

As illustrated in FIG. 1, the gear device 1 according to this embodiment comprises an outer cylinder 2, an internal-teeth pin 3, a carrier 4, a main bearing 6, a crankshaft 10, a motor 12, an oscillation gear 14, and a brake 16.

The outer cylinder 2 is configured to be fixable to one (e.g., a base of a robot) of two counterpart members, and is capable of functioning as a casing of the gear device 1. The outer cylinder 2 is formed into an approximately circular cylindrical shape having an inner peripheral surface. Specifically, the outer cylinder 2 is fastened to the base of the robot by a bolt (fastener) or the like.

A large number of the internal-tooth pins 3 are arranged on the inner peripheral surface of the outer cylinder 2 at even intervals in a circumferential direction of the inner peripheral surface. The internal-tooth pins 3 function as internal teeth meshable with teeth 14a of the oscillation gear 14 composed of an externally toothed gear. The number of the teeth 14a of the oscillation gear 14 is set to be slightly less than the number of the internal-tooth pins 3. In this embodiment, the oscillation gear 14 is used plurally (e.g., two).

The carrier 4 is configured to be fixable to the other counterpart member (e.g., a turning body of the robot). Specifically, the carrier 4 is fastened to the turning body of the robot by a non-illustrated bolt (fastener) or the like. The carrier 4 is housed inside the outer cylinder 2 while being disposed in a coaxial relation to the outer cylinder 2. The carrier 4 is supported by a pair of the main bearings 6 provided in axially spaced-apart relation, in such a manner as to be relatively rotatable with respect to the outer cylinder 2. Thus, the carrier 4 is relatively rotatable with respect to the outer cylinder 2, about a common axis. When the carrier 4 is relatively rotated with respect to the outer cylinder 2, the turning body of the robot is turned with respect to the base.

It should be noted that, although FIG. 1 illustrates an example where each of the main bearings 6 has an outer race composed of a member separate from the outer cylinder 2, and an inner race composed of a portion of the carrier 4, the embodiment is not limited thereto. For example, the main bearing 6 may have an outer race composed of a member separate from the outer cylinder 2, and an inner race composed of a member separate from the carrier 4. Alternatively, the main bearing 6 may have an outer race composed of a portion of the outer cylinder 2, and an inner race composed of a member separate from the carrier 4.

Further, although this embodiment shows an example where the carrier 4 is fastened to the turning body in a rotatable manner, and the outer cylinder 2 is fixed to the base in an immovable manner, the reverse arrangement may be employed. That is, the outer cylinder 2 may be fastened to the turning body, and the carrier 4 may be fastened to the base. In this case, when the outer cylinder 2 is relatively rotated with respect to the carrier 4, the turning body of the robot is turned with respect to the base. An oil seal 8 is provided between the outer cylinder 2 and the carrier 4.

The carrier 4 comprises a base plate portion 21, an end plate portion 22, a shaft portion 23, and a cover portion 24. The base plate portion 21 is disposed inside the outer cylinder 2 at a position adjacent to one end of the outer cylinder 2 in a direction of a rotational axis (i.e., axial direction) of the carrier 4. The shaft portion 23 axially extends from the base plate portion 21 toward the end plate portion 22. The shaft portion 23 is provided plurally (in this embodiment, six), wherein the shaft portions 23 are arranged at circumferentially even intervals. It should be understood that, although the carrier 4 in this embodiment has a structure in which the base plate portion 21 and the shaft portions 23 are integrally formed as a carrier base, the embodiment is not limited thereto. That is, the shaft portions 23 do not necessarily have to be formed integrally with the base plate portion 21. More specifically, each of the shaft portions 23 may be formed as a separate body from the base plate portion 21, and fastened to the base plate portion 21 by a fastener such as a bolt. It should be noted that the circumferential intervals of the shaft portions 23 do not necessarily have to be even.

A surface of the base plate portion 21 on a side opposite to the end plate portion 22 is formed with a plurality of (in this embodiment, six) recesses 21a. The recesses 21a are provided around a radially central region of the carrier 4 at even intervals. The recesses 21a are provided in the surface of the base plate portion 21 on a side opposite to a surface thereof provided with the shaft portions 23, and arranged at respective positions between respective pairs of adjacent ones of the shaft portions 23.

The end plate portion 22 is formed into a plate shape having a diameter equal to that of the base plate portion 21, and disposed in spaced-apart relation to the base plate portion 21. A surface of the end plate portion 22 on a side opposite to the base plate portion 21 is formed with a plurality of (in this embodiment, six) recesses 22a. The recesses 22a are provided around the radially central region of the carrier 4 at even intervals.

Each of the shaft portions 23 is fastened to the end plate portion 22 by a bolt (fastener) 5. As a result, the base plate portion 21 and the end plate portion 22 are integrated together. Further, a housing space for housing the oscillation gears 14 is formed between the base plate portion 21 and the end plate portion 22.

The cover portion 24 is disposed on the side opposite to the base plate portion 21 with respect to the end plate portion 22 to cover an outer end surface of the end plate portion 22. The cover portion 24 has a cover body 24a, and a flange 24b formed around the cover body 24a and fastenable to the end plate portion 22.

The cover body 24a has a bottom wall 24c, and a side (outer peripheral) wall 24d extending from an outer periphery of the bottom wall 24c in the axial direction of the carrier 4. That is, the cover body 24a is formed into a bottomed tubular shape in which one of axially opposite ends is opened.

The flange 24b is a portion protruding radially outwardly from an axial distal edge of the side wall 24d. The flange 24b is formed with an insertion hole for allowing a bolt (fastener) 26 to be penetratingly inserted thereinto. It is to be understood that, although the flange 24b is formed to have a size capable of covering one axial end surface of the outer cylinder 2, the embodiment is not limited thereto.

The carrier 4 has a through-hole 4a formed in the radially central region thereof to axially penetrate through the base plate portion 21, the end plate portion 22 and the cover portion 24. A tubular body 30 is fitted into the through-hole 4a in such a manner as to axially penetrate through the carrier 4. It should be noted that the tubular body 30 may be omitted, and the through-hole 4a may also be omitted.

One end of the tubular body 30 is in close contact with an inner peripheral surface of the base plate portion 21 defining a part of the through-hole 4a, and the other end of the tubular body 30 is in close contact with an inner peripheral surface of the cover member 24 defining a part of the through-hole 4a. An oil seal 35 is provided between the end plate portion 22 and an intermediate portion of the tubular body 30. This makes it possible to seal a space defined between the base plate portion 21 and the end plate portion 22, and a space defined between the end plate portion 22 and the cover portion 24.

The carrier 4 has a plurality of (in this embodiment, six) crankshaft holes 4b formed around the through-hole 4a. The crankshaft holes 4b are formed at respective positions between respective pairs of adjacent ones of the shaft portions 23, and arranged at circumferentially even intervals. Each of the crankshaft holes 4b is formed to have a size capable of allowing the crankshaft 10 to be penetratingly inserted thereinto, and penetrate through the base plate portion 21, the end plate portion 22 and the cover portion 24 in the axial direction of the carrier 4. It should be noted that the circumferential intervals of the crankshaft holes 4b do not necessarily have to be even.

Each of the crankshaft holes 4b has a base plate portion-side region which penetrates through a bottom of a corresponding one of the recesses 21a of the base plate portion 21. That is, each of the recesses 21a of the base plate portion 21 is formed to surround a corresponding one of the crankshaft holes 4b. Each of the crankshaft holes 4b also has an end plate portion-side region which penetrates through a bottom of a corresponding one of the recesses 22a of the end plate portion 22. That is, each of the recesses 22a of the end plate portion 22 is formed to surround a corresponding one of the crankshaft holes 4b. Each of the recesses 21a and the recesses 22a has a circular shape, when view along the axial direction of the carrier 4.

The crankshaft 10 is penetratingly inserted into each of the crankshaft holes 4b of the carrier 4. That is, the crankshaft 10 is provided plurally (in this embodiment, e.g., six), wherein the crankshafts 10 are arranged around the radially central region of the carrier 4 at even intervals. Each of the crankshafts 10 has an axial length less than that of the carrier 4, i.e., it is fully housed inside the carrier 4.

Each of the crankshafts 10 is rotatably supported by the carrier 4 via a pair of first and second crankshaft bearings 32, and, in this supported state, installed in a posture where it extends parallel to the rotational axis of the carrier 4. The first crankshaft bearing 32 is fitted into the end plate portion-side region of the crankshaft hole 4b. The second crankshaft bearing 32 is fitted into the base plate portion-side region of the crankshaft hole 4b.

Each of the crankshafts 10 has a crankshaft body 10c, and a plurality of (in this embodiment, two) eccentric portions 10a formed integrally with the crankshaft body 10c. The eccentric portions 10a are disposed in an axially side-by-side relation at respective positions between a pair of journal regions 10d of the crankshaft 10 on which the crankshaft bearings 32 are mounted, respectively. Each of the eccentric portions 10a is formed into a columnar shape whose axis is eccentric with respect to an axis of the crankshaft body 10c by a given eccentric amount. Further, the eccentric portions 10a are formed in the crankshaft 10 to have a phase difference of a given angle therebetween. It should be noted that the number of the eccentric portions 10a may be one, or three or more.

Each of the crankshafts 10 is subjected to spline machining at opposite ends thereof extending outwardly from the respective journal regions 10d.

Each of the oscillation gears 14 is composed of an externally toothed gear having an outer peripheral portion formed with the large number of teeth 14a, and formed to have an outer diameter slightly less than an inner diameter of the outer cylinder 2. Each of the oscillation gears 14 is attached to a corresponding one of the eccentric portions 10a of the crankshaft 10 through a roller bearing 34. The oscillation gears 14 are operable, upon rotation of the respective crankshafts 10, to be oscillatingly rotated interlockingly with eccentric rotation of the eccentric portions 10a of the crankshafts 10, while sequentially changing a meshing position with respect to the internal-tooth pins 3 on the inner peripheral surface of the outer cylinder 2.

Each of the oscillation gears 14 has a central through-hole 14b, a plurality of eccentric-portion insertion holes 14c, and a plurality of shaft-portion insertion holes 14d. The central through-hole 14b is formed in a radially central region of the oscillation gear 14. In the case where the tubular body 30 is omitted, the central through-hole 14b may be omitted.

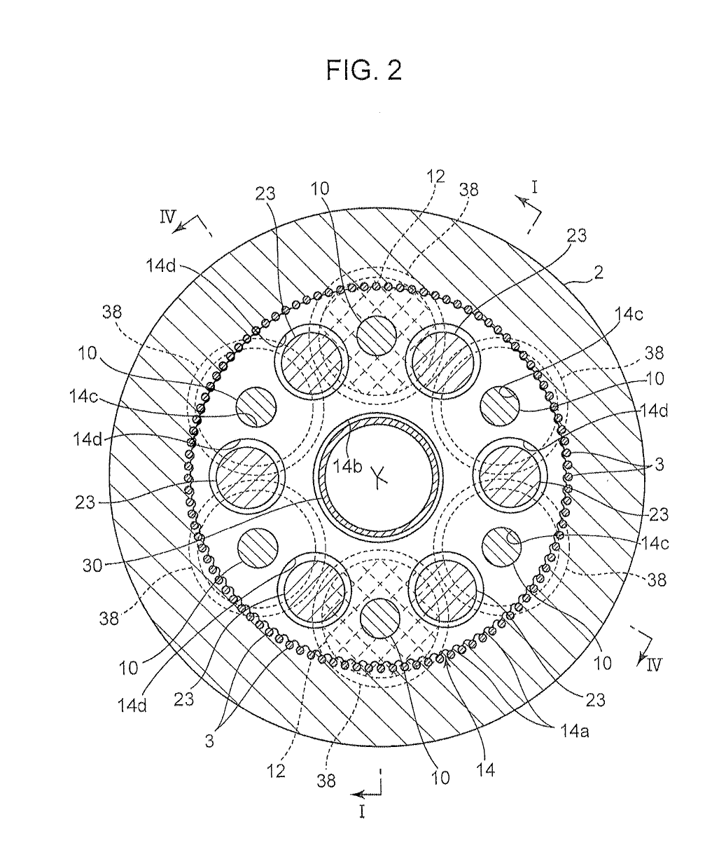

The eccentric-portion insertion holes 14c are provided around the central through-hole 14b of the oscillation gear 14 at circumferentially even intervals. Each of the eccentric portions 10a of the crankshafts 10 is penetratingly inserted in a corresponding one of the eccentric-portion insertion holes 14c, under interposition of the roller bearing 34 therebetween. In FIG. 2, the illustration of the roller bearing 34 is omitted. In the case where the crankshafts 10 are not arranged at circumferentially even intervals, the eccentric-portion insertion holes 14c are provided at respective positions set accordingly.

The shaft-portion insertion holes 14d are provided around the central through-hole 14b of the oscillation gear 14 at circumferentially even intervals. The shaft-portion insertion holes 14d are formed at respective positions between respective pairs of circumferentially adjacent ones of the eccentric-portion insertion holes 14c. Each of the shaft portions 23 is penetratingly inserted into a corresponding one of the shaft-portion insertion holes 14d with a clearance. In the case where the shaft portions 23 are not arranged at circumferentially even intervals, the shaft-portion insertion holes 14d are provided at respective positions set accordingly.

The carrier 4 is provided with a plurality of (in this embodiment, six) motor installation sections 38. Each of the motor installation sections 38 is a portion capable of holding the motor 12, and they are arranged around the radially central region of the carrier 4 at circumferentially even intervals. The motor installation sections 38 are arranged at respective positions corresponding to the positions of the crankshafts 10. Thus, in the case where the crankshafts 10 are not arranged at circumferentially even intervals, the motor installation sections 38 are also not arranged at circumferentially even intervals, correspondingly.

Each of the motor installation sections 38 is provided in the cover body 24a of the cover portion 24 at a position opposed to a corresponding one of the recesses 22a of the end plate portion 22. Each of the motor installation sections 38 is formed integrally with the cover body 24a on an inner surface of the bottom wall 24c of the cover body 24a. Each of the motor installation sections 38 axially protrudes from the bottom wall 24c toward the end plate portion 22 (or the base plate portion 21). Each of the motor installation sections 38 is formed into an annular shape concentric with the corresponding one of the crankshaft holes 4b, when viewed in the axial direction of the carrier 4. That is, each of the motor installation sections 38 has a shape in which a space is formed thereinside. Each of the motor installation sections 38 has an inner peripheral surface with an inner diameter enough to form a gap with respect to an outer diameter of the motor 12, and the inside space in each of the motor installation sections 38 is formed to allow the motor 12 to be inserted thereinto.

The motor 12 is disposed inside the carrier 4. A portion of the motor 12 is inserted inside the inside space of the motor installation section 38.

The motor 12 comprises a rotor 41 attached to one, first, end (an end on the side of the motor installation sections 38) of the crankshaft 10, and a stator 42 fixed to the carrier 4. The rotor 41 is formed into a circular cylindrical shape, and spline-coupled to the first end of the crankshaft 10 in a radially central portion thereof, in such a manner as to become concentric with the crankshaft 10. A magnet 41a is fixed to an outer peripheral surface of the rotor 41.

The rotor 41 is equipped with an encoder 45 for detecting a rotational amount of the crankshaft 10.

The stator 42 comprises a coil 42a and an iron core 42b. The stator 42 is disposed radially outward of the rotor 41b in such a manner as to allow an inner peripheral surface of the iron core 42b to face the outer peripheral surface of the rotor 41.

The motor 12 is composed of a radial gap motor in which the stator 42 and the rotor 41 are radially opposed to each other. However, the motor 12 is not limited to a radial gap type. That is, the motor 12 may be composed of an axial gap motor in which the stator 42 and the rotor 41 are axially opposed to each other.

A spacer 52 is provided inside the motor installation section 38. The spacer 52 is designed to fill a gap between the motor installation section 38 and the stator 42 of the motor 12, and formed into a tubular shape. The spacer 52 is fitted inside the motor installation section 38 and thereby fixed to the motor installation section 38.

Then, one axial end (end on the side of the cover portion 24) of the stator 42 is fitted inside the spacer 52, so that the motor 12 is fixed to the motor installation section 38. The motor 12 is disposed on a side opposite to the base plate portion 21 with respect to the end plate portion 22a, and thereby can avoid interference with the shaft portions 23.

The spacer 52 has an outer diameter corresponding to the inner diameter of the motor installation section 38. Further, the spacer 52 has a thickness suitable for a size of the motor to be disposed inside the carrier 4. Such a spacer 52 can be selected from a plurality of types of spacers having different thicknesses. The coil 42a and the iron core 42b exist around an outer periphery of the motor 12. The coil 42a and the iron core 42b (stator 42) are inserted inside the motor installation section 38 together with the spacer 52, so that it becomes possible to reduce burden of an installation work for the motor 12 (stator 42). In addition, when a motor 12 appropriate to the required torque is selected, an appropriate spacer 52 can be selected to allow the motor 12 to be installed without occurrence of a gap with respect to the motor installation section 38.

The brake 16 comprises: a rotary plate 16a attached to the other, second, end (an end on the side of the base plate portion 21) of the crankshaft 10; an electromagnet 16b fixed to the base plate portion 21 (carrier 4); and a braking plate 16c supported by the electromagnet 16b in an axially reciprocatingly movable manner. The rotary plate 16a has a radially central portion spline-coupled to the second end of the crankshaft 10, wherein it is kept in a posture perpendicular to the crankshaft 10. The braking plate 16c is made of a magnetic material, and can take two states: a braking state in which it is pressed against the rotary plate 16a and a normal state in which it is kept away from the rotary plate 16a, according to off-on control of the electromagnet 16b.

The electromagnet 16b is formed into an annular shape, and installed inside the recess 21a of the base plate portion 21. The recess 21a functions as a brake installation section as a section for holding the brake 16. That is, in this embodiment, a plurality of (in this embodiment, six) brake installation sections are provided. The recesses 21a are arranged around the radially central region of the carrier 4 at even intervals, as mentioned above. Each of the recesses 21a is formed into an annular shape which is concentric with a corresponding one of the crankshaft holes 4b and has an opening through which a corresponding one of the crankshafts 10 penetrates. The recesses 21a are provided on a side opposite to the motor installation sections 38 with respect to the oscillation gears 14. Further, the recesses 21a are provided, respectively, at the same positions as those of the motor installation sections 38 in a circumferential direction of the carrier 4

A brake positioning segment 21b which extends outwardly from a bottom of the recess 21a in the axial direction of the carrier 4 is formed on the recess 21a around the peripheral portion of the crankshaft holes 4b. The brake positioning segment 21b is formed into a circular cylindrical shape concentric with the crankshaft hole 4b. The electromagnet 16b has inner edge portion formed with a depression having a shape corresponding to the shape of the brake positioning segment 21b. When the brake positioning segment 21b is fitted into the depression of the electromagnet 16b, the electromagnet 16b is positioned with respect to the base plate portion 21. Then, the electromagnet 16b is fixed to the base plate portion 21 by a bolt (fastener) 47.

The second crankshaft bearing 32 is mounted inside the brake positioning segment 21b. Thus, the brake positioning segment 21b also functions as a supporting section for the crankshaft 10.

The carrier 4 is provided with a plurality of plugging members 49 for plugging respective openings formed by the recesses 21a provided in the base plate portion 21. Specifically, each of the recesses 21a is formed in an axially outer surface of the base plate portion 21, and a space formed by the recess 21a is communicated with the corresponding crankshaft hole 4b. Each of the plugging members 49 plugs an axial end opening of the space in a corresponding one of the recesses 21a.

In this embodiment, as illustrated in FIG. 2, the motor 12 is installed in each of two of the six motor installation sections 38. In FIG. 2, the two motors 12 are arranged around the rotational axis of the carrier 4 at intervals of 180 degrees.

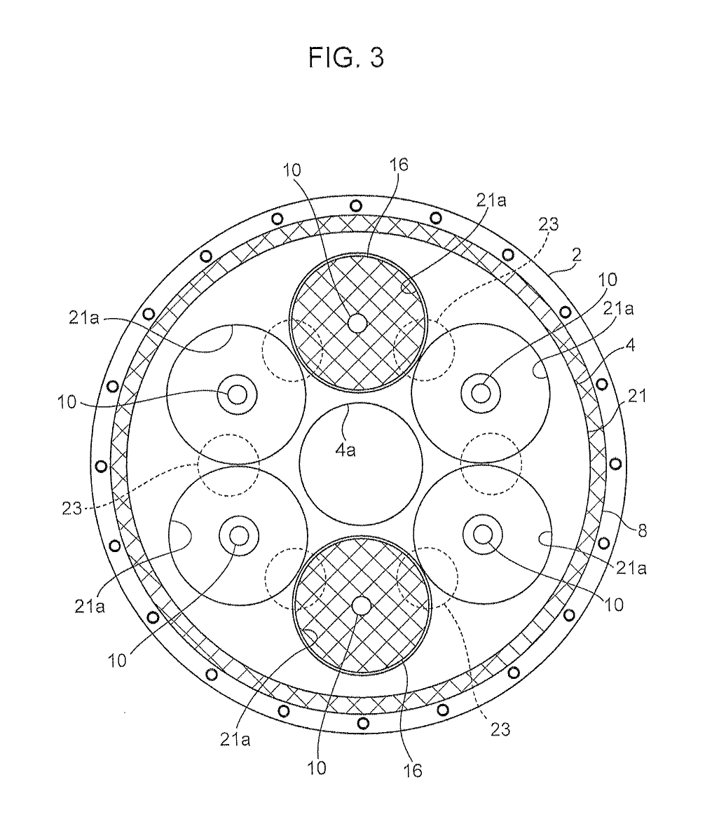

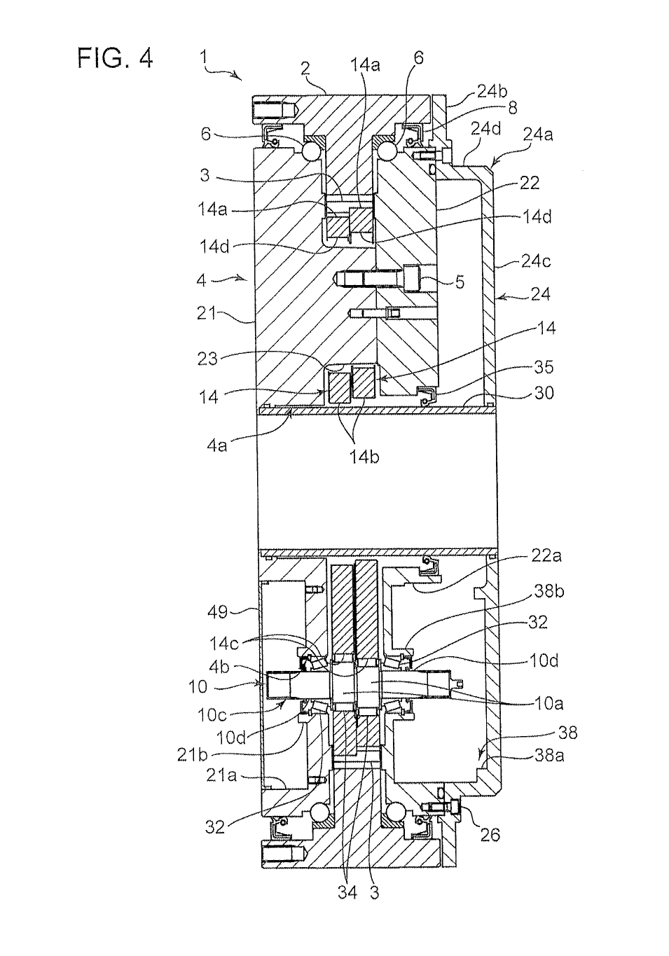

FIG. 3 is a side view of the gear device 1, when viewed rightwardly from the left side in FIG. 1, wherein the plugging members 49 are removed therefrom. As illustrated in FIG. 3, in this embodiment, the brake 16 is installed in each of two of the six recesses 21a (brake installation sections). The two brakes 16 are arranged, respectively, at the same circumferential positions as those of the two motors 12. In other words, each of the two pairs of the motor 12 and the brake 16 are installed and coupled to the same crankshaft 10. Thus, each of the brake 16 is operable to prevent rotation of a corresponding one of the crankshafts 10 directly receiving a driving force from the respective motors 12 installed in two of the motor installation sections 38. As illustrated in FIG. 4, the remaining crankshafts 10 are not installed with any of the motor 12 and the brake 16. It is to be understood that the motor 12 may be attached to a different crankshaft 10 from a crankshaft 10 that the brake 16 is attached to.

The motor 12 may be installed in each of all of the motor installation sections 38, and the brake 16 may be installed in each of all of the recesses 21a (brake installation sections). In this case, six motors 12 and six brakes 16 are used.

An operation of the gear device 1 according to this embodiment will be described below.

Upon driving of the two motors 12, the two crankshafts 10 each installed with the motor 12 are rotated about their respective axes. Then, along with the rotation of the crankshafts 10, the eccentric portions 10a of the crankshafts 10 are eccentrically rotated. Thus, the oscillation gears 14 are rotated interlockingly with the eccentric rotation of the eccentric portions 10a, while sequentially changing a meshing position between the teeth 14a and the internal-tooth pins 3 of the outer cylinder 2. This causes relative rotation between the outer cylinder 2 and the carrier 4. In this embodiment, the outer cylinder 2 is immovable because it is fixed to the base, so that the carrier 4 is rotated about its axis according to oscillating rotation of the oscillation gears 14. Therefore, the carrier 4 and the turning body are relatively rotated with respect to the outer cylinder 2 and the base at a rotational speed reduced from a rotational speed of each of the motors 12.

A process for adjusting a torque to be generated from the gear device 1 will be described below. In the gear device 1, the motor 12 is installed inside the motor installation section 38 through the spacer 52. This state may be continued without any modification when a torque generatable by the motor 12 meets a required torque. However, if it fails to meet the required torque, the motor 12 has to be replaced with a larger-size motor capable of generating a larger torque.

When the motor 12 is replaced with a larger-size motor, the bolt 26 is first unfastened, and the cover portion 24 is detached from the end plate portion 22. In this process, the rotor 41 of the motor 12 is left on the side of the crankshaft 10, and disengaged from the motor installation section 38, the spacer 52 and the stator 42 of the motor 12. Further, the plugging members 48 are detached from the base plate portion 21. Then, the rotor 41 of the motor 12 is detached from the crankshaft 10, and a rotor 41 of a newly selected motor 12 selected according to the required torque is attached to the crankshaft 10. Then, a stator 42 corresponding to the rotor 41 of the newly selected motor 12 and a newly selected spacer 52 having a thickness appropriate to the stator 42 are installed to the motor installation section 38. Further, according to need, the brake 16 is replaced to another type. Then, the cover portion 24 installed with the stator 42 of the newly selected motor 12 and the newly selected spacer 52 is attached to the end plate portion 22 so that the rotor 41 is inserted into the stator 42. Then, the plugging members 49 are attached to the base plate portion 21. In this way, the process for adjusting a torque to be generated from the gear device 1 is completed.

As described above, in this embodiment, when the crankshaft 10 is driven by the motor 12 installed in the motor installation section 38 of the carrier 4, relative rotation is caused between the carrier 4 and the outer cylinder 2. In this process, a magnitude of torque causing the relative rotation between the carrier 4 and the outer cylinder 2 depends on a size of the motor 12 driving the crankshaft 10.

In this embodiment, the gap between the motor installation section 38 and the motor 12 is filled by the spacer 52. In other words, the motor installation section 38 provided in the carrier 4 has an installation size greater than a size of the motor 12. Thus, there remains a possibility of allowing the motor 12 to be replaced with a motor 12 having a larger size. Thus, by replacement with a larger-size motor 12, the gear device 1 can generate a larger torque. In this case, the motor 14 can be replaced without subjecting the carrier 4 to special processing. In other words, a plurality of types of gear devices 1 capable of generating different torques can be obtained using common components in terms of the outer cylinder 2, the carrier 2 and the main bearings 6.

In this embodiment, the motor installation section 38 is formed into an annular shape, and the spacer 52 is fitted inside the motor installation section 38, so that it becomes possible to stably hold the spacer 52. In addition, the spacer 52 is formed into a tubular shape, and thereby can hold the motor 12 over the entire circumstances of the motor 12. Thus, it becomes possible to further stably hold the motor 12.

In this embodiment, the motor 12 is composed of a radial gap motor whose cylinder size varies depending on an output torque. Thus, depending on the presence or absence of the spacer 52 or a thickness of the spacer 52, a larger-size motor 12 can be installed. This makes it possible to increase a magnitude of the output torque to cope with a change of the required torque.

It should be understood that the present invention is not limited to the above embodiment, but various changes and modifications may be made therein without departing from the spirit and scope of the present invention as set forth in appended claims. As an example, in the above embodiment, each of the crankshaft 10, the motor installation section 38 and the recess 21a (brake installation section) is provided six in number. However, the present invention is not limited thereto. For example, each of the crankshaft 10, the motor installation section 38 and the recess 21a may be provided one, or two or more, preferably, four or eight, in number.

Although FIG. 1 illustrates an example in which a plate disposed on the left side is constructed as the base plate portion 21, and a plate disposed on the right side is constructed as the end plate portion 22, the reversed structure may be employed. That is, the plate disposed on the left side may be constructed as the end plate portion 22, and the plate disposed on the right side may be constructed as the base plate portion 21. In this structure, the plate disposed on the right side is integrally formed with the shaft portions to serve as the base plate portion 21, and the cover portion 24 is fastened to this base plate portion 21. Further, the recesses 21a (brake installation sections) are provided in the end plate portion 22. Then, the motor 12 is installed between the base plate portion 21 and the cover portion 24, and the brake 16 is installed to the end plate portion 22. In thus structure, the motor installation section 38 is also provided in the cover portion 24.

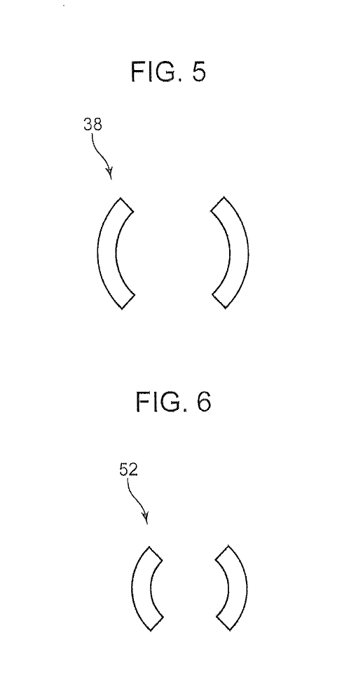

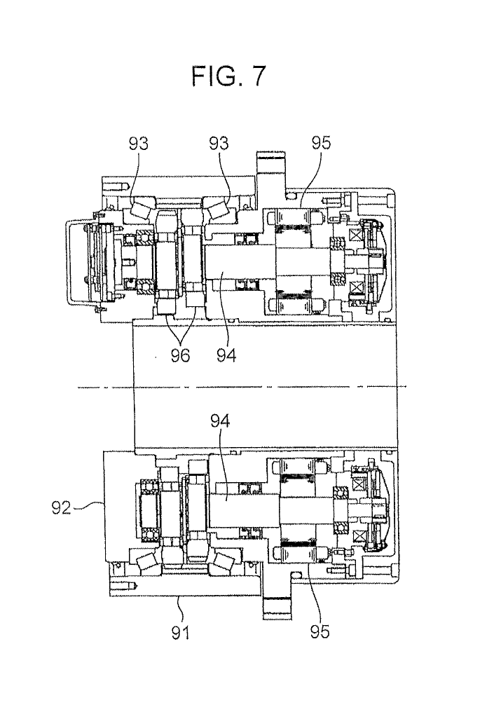

In the above embodiment, the motor installation section 38 is formed into an annular shape. However, the embodiment is not limited thereto, but the motor installation section 38 may have any other suitable structure capable of forming a space thereinside. For example, as illustrated in FIG. 5, the motor installation section 38 may have a structure comprising a plurality of arc-shaped portions arranged in circumferentially spaced-apart relation. Alternatively, the motor installation section 38 may have a structure with a C shape (arc shape) in cross-section, i.e., an annular shape having one discontinuous portion, instead of an annular shape continuous over the entire circumstance thereof, in cross-section.

In the above embodiment, the spacer 52 is formed into a tubular shape. However, the embodiment is not limited thereto, but the spacer 52 may have any other suitable structure capable of forming a space thereinside. For example, as illustrated in FIG. 6, the spacer 52 may have a structure comprising a plurality of arc-shaped portions arranged in circumferentially spaced-apart relation. Alternatively, the spacer 52 may have a structure with a C shape (arc shape) in cross-section, i.e., an annular shape having one discontinuous portion, instead of an annular shape continuous over the entire circumstance thereof, in cross-section.

The above embodiment will be outlined below.

The above embodiment discloses an eccentric oscillation gear device which comprises: an outer cylinder; a carrier provided with a motor installation section having an inside space; a main bearing configured to permit relative rotation between the outer cylinder and the carrier; a motor at least partly inserted into the inside space of the motor installation section; a spacer filling a gap between the motor installation section and the motor; and a crankshaft configured to be rotated in response to receiving a driving force from the motor, in such a manner as to cause relative rotation between the outer cylinder and the carrier.

In the above embodiment, when the crankshaft is driven by the motor installed in the motor installation section of the carrier, relative rotation is caused between the carrier and the outer cylinder. In this process, a magnitude of torque causing the relative rotation between the carrier and the outer cylinder depends on a size of the motor driving the crankshaft.

In the above embodiment, a gap between the motor installation section and the motor inserted inside the motor installation section is filled by the spacer. In other words, the motor installation section provided in the carrier has an installation size greater than a size of the motor. Thus, there remains a possibility of allowing the motor to be replaced with a motor having a larger size. Thus, by replacement with a larger-size motor, the gear device can generate a larger torque. In this case, the motor can be replaced without subjecting the carrier to special processing. In other words, a plurality of types of gear devices capable of generating different torques can be obtained using common components in terms of the outer cylinder, the carrier and the main bearing. Thus, even in a situation where the required torque is changed from an initial specification, it becomes possible to readily cope with the change, and contribute to a reduction in burden of stocks.

The motor installation section may be formed into an annular shape. In this case, the spacer may be formed into a tubular shape, wherein an outer peripheral surface of the spacer may be in contact with an inner peripheral surface of the motor installation section, and an inner peripheral surface of the spacer may be in contact with the motor.

In the embodiment having this feature, the spacer is fitted inside the motor installation section formed into an annular shape, so that it becomes possible to stably hold the spacer. In addition, the spacer is formed into a tubular shape, and thereby can hold the motor over the entire circumstances of the motor. Thus, it becomes possible to further stably hold the motor.

The motor may be composed of a radial gap motor. A cylinder size of the radial gap motor varies depending on an output torque. In the above embodiment, the motor is composed of a radial gap motor. Thus, depending on the presence or absence of the spacer or a thickness of the spacer, a motor having a larger cylinder size can be installed. This makes it possible to increase a magnitude of the output torque to cope with a change of the required torque.

Each of the crankshaft and the motor installation section may be provided plurally, wherein the motor may be fitted into at least one of the plurality of motor installation sections. In this case, the spacer may be used in the at least one motor installation section fitted with the motor.

The above embodiment also discloses a method of adjusting torque of an eccentric oscillation gear device, wherein the eccentric oscillation gear device comprises: an outer cylinder; a carrier provided with a motor installation section having an inside space; a main bearing configured to allowing relative rotation between the outer cylinder and the carrier; a motor installed in the motor installation section; and a crankshaft configured to be rotated in response to receiving a driving force from the motor, in such a manner as to cause relative rotation between the outer cylinder and the carrier. The method comprises; selectively determining a motor having a size appropriate to a required torque, within a size of the inside space of the motor installation section; inserting at least a portion of the determined motor into the inside space to install the motor in the motor installation section, while filling a gap between the motor installation section and the motor by using a spacer, thereby adjusting a relative rotation torque to be generated between the outer cylinder and the carrier.

As mentioned above, the above embodiment makes it possible to readily cope with a change of the required torque and contribute to a reduction in burden of stocks.

This application is based on Japanese Patent application No. 2014-173759 filed in Japan Patent Office on Aug. 28, 2014, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An eccentric oscillation gear device comprising:
an outer cylinder;
a carrier provided with a motor installation section having an inside space;
a main bearing configured to permit relative rotation between the outer cylinder and the carrier;
a motor at least partly inserted into the inside space of the motor installation section;
a spacer filling a gap between the motor installation section and the motor; and
a crankshaft configured to be rotated in response to receiving a driving force from the motor, in such a manner as to cause relative rotation between the outer cylinder and the carrier.

2. The eccentric oscillation gear device as defined in claim 1, wherein
the motor installation section is formed into an annular shape; and
the spacer is formed into a tubular shape, wherein an outer peripheral surface of the spacer is in contact with an inner peripheral surface of the motor installation section, and an inner peripheral surface of the spacer is in contact with the motor.

3. The eccentric oscillation gear device as defined in claim 1, wherein the motor is composed of a radial gap motor.

4. The eccentric oscillation gear device as defined in claim 1, wherein each of the crankshaft and the motor installation section is provided plurally, and wherein
the motor is fitted into at least one of the plurality of motor installation sections, and
the spacer is used in the at least one motor installation section fitted with the motor.

5. A method of adjusting torque of an eccentric oscillation gear device, the eccentric oscillation gear device comprising: an outer cylinder; a carrier provided with a motor installation section having an inside space; a main bearing configured to permit relative rotation between the outer cylinder and the carrier; a motor installed in the motor installation section; and a crankshaft configured to be rotated in response to receiving a driving force from the motor, in such a manner as to cause relative rotation between the outer cylinder and the carrier, the method comprising; selectively determining a motor having a size appropriate to a required torque, within a size of the inside space of the motor installation section; inserting at least a portion of the determined motor into the inside space to install the motor in the motor installation section, while filling a gap between the motor installation section and the motor by using a spacer, thereby adjusting a relative rotation torque to be generated between the outer cylinder and the carrier.
